(19) United States
(12) Patent Application Publication
(10) Pub. No.: US 2009/0184168 A1
(43) Pub. Date: Jul. 23, 2009

(54) RECYCLABLE PLASTIC CARDS AND METHODS OF MAKING SAME

(76) Inventors: Roger Ricketts, Apple Valley, MN (US); John Tomczyk, Shoreview, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/357,306

(22) Filed: Jan. 21, 2009

Related U.S. Application Data
(60) Provisional application No. 61/011,774, filed on Jan. 17, 2008.

(51) Int. Cl. G06K 19/067; B32B 3/10

(52) U.S. Cl. 235/492; 428/195.1

(57) ABSTRACT

A recyclable plastic card and method of manufacturing the same. The plastic card is made from an unfilled or filled polymeric material, such as polypropylene or polyethylene material, that can be readily printed, embossed, thermally imaged, surface printed with a variety of inks and printing methodologies, laminated, and/or polished, such that the card will perform acceptably in a retail point of sale machine readable activation system. The plastic card performs similarly to a PVC card in retail point of sale systems or environments, and meets ISO requirements for thickness and dimensional stability regarding heat and humidity exposure.

### RELATED APPLICATION

This application claims the benefit of U.S. Provisional Application No. 61/011,774, filed Jan. 17, 2008, which is incorporated herein by reference in its entirety.

### FIELD OF THE INVENTION

The present invention relates generally to plastic cards, such as transaction, information, identification, and stored value cards. More particularly, the invention relates to a plastic card, such as a credit card or gift card, manufactured from recyclable polymeric materials, such as a filled polypropylene or filled polyethylene, that can be printed, polished, and/or imaged while meeting or exceeding industry standards for transaction cards.

### BACKGROUND OF THE INVENTION

Plastic cards are used frequently in everyday commerce and are becoming more prevalent in a variety of applications. Plastic cards can include transaction, information, identification, and/or stored value cards and like, such as, for example, credit cards, debit cards, gift cards, phone cards, identification cards or badges, driver licenses, key cards, break-off cards with attached key fobs, lenticular cards, and the like. The plastic cards can include printed indicia, such as a card number, pin number, identification information, name, address, expiration date, patent numbers, disclaimers, financial institution, store information, and the like. Further, plastic cards, such as financial transaction cards, can comprise a magnetic stripe or RFID chip that is adhered, embedded, or embossed on the card. The magnetic stripe or its equivalent is encoded with the card information and/or account information. As the number of cards being produced increases, the amount of scrap material resulting from processing plastic cards and from discarded plastic cards themselves continues to increase. Plastic cards are typically manufactured using a polymeric material such as polyvinyl chloride (PVC) or styrene. These materials provide the desired properties and characteristics of the plastic cards, such as, for example, rigidity, durability, and price. For example, credit cards must meet certain ISO standards, such as, for example, ISO/IEC 7810:2003 entitled “Identification Cards—Physical Characteristics,” ISO/IEC 7813:2001 entitled “Identification Cards—Financial transaction cards” and ISO/IEC 7816.1:1987(E) entitled “Identification Cards—Integrated circuit(s) cards with contacts,” both of which are incorporated herein by reference. However, materials such as PVC and styrene are perceived as being not environmentally friendly in that they do not biodegrade readily and cannot easily be recycled because there is no established recycling stream. PVC, for example, raises environmental concerns with the use of vinyl chloride, phthalate plasticizers, and dioxin when such material is burned. Furthermore, PVC and polystyrene are made from either crude oil or natural gas, and can therefore be subject to price fluctuations of oil, and depend on foreign oil supplies.

Recently, there has been a trend to adopt “green” materials, products, and practices. Green materials are materials that have a lesser impact on the environment in a variety of ways including reducing the amount of material used, reusing or recycling the material, using material that is renewable, is biodegradable, is biocompostable, is sustainable, is inert in a landfill environment, contains no toxins in its manufacture, is locally produced, and/or leaves a lower carbon footprint.

Green plastics are those plastics that possess at least some of the characteristics listed above. Such plastics can include, for example, glycol-modified polyethylene terephthalate (PETG), polylactic acid (PLA), polyhydroxyalkanoate polymers (PHA), starch, recycled paper, polypropylene, high density polyethylene (HDPE), recycled PVC, bio-styrene and -PVC (additives to impart biodegradable characteristics), cellulose acetate, and recycled paper with biodegradable laminate.

These green plastics can be generally organized into three categories: biomaterials, oxo plastics, and recycled content. The biomaterials, or those derived from natural sources such as sugar-based sources like corn, flax, beets, sugar cane, soybeans, and the like, include PLA, PHA, and Cereplast™-brand renewable plastics. The oxo plastics can include plastics that contain an oxo oil additive as part of liquid stabilizer compositions, for example oxo-PVC and oxo-styrene. Recycled content are materials that have been recycled and reused such as, for example, r-PVC, r-styrene, and r-APET.

Steps have been taken to manufacture environmentally friendlier plastic cards, such as credit cards, using materials such as PETG and PLA. See, for example, http://www.treehugger.com/files/2006/08/triodos_eco_cre.php and http://blog.tmcnet.com/green-blog/green-credit-card-to-help-reduce-carbon.asp. Further, recycled plastics have been used to make plastic cards, as described in U.S. Publication No. 2007/0243362, entitled “Sheet Stock and Cards Made From Recycled Plastic Scrap Material and Methods.” However, these materials and/or methods may be cost restrictive, require additional processing steps for sufficient printing, embossing, polishing characteristics, have perceived by some as not being green material, such as in the case of PVC, and/or may lack sufficient characteristics to create a product that meets the ISO standards for such cards.

There remains a need for a cost-efficient, recyclable plastic card that meets the requirements of printing, press polishing, magnetic stripe application, imaging, and/or encoding while meeting many of the characteristics of the current ISO specification for card and imaging encoding.

### SUMMARY OF THE INVENTION

The present invention resolves many of the above-described deficiencies and drawbacks inherent with both currently used, non-“green” plastics, and the “green” plastics mentioned above. In embodiments of the invention, a plastic card, such as a transaction card, comprises a filled polypropylene or polyethylene material. The plastic card can be recycled, yet performs similarly to a PVC card and can be activated at retail point of sale systems or environments. The material provides sufficient durability to meet industry and/or many of the requirement of the ISO 7810:2003 specification for card manufacturing and ISO 7811-2 or ISO 7811-6 standard for magnetic stripe specification, and can be readily printed, embossed, thermally imaged, surface printed with a variety of inks and printing methodologies, laminated, and/or polished, such that the card will perform acceptably in a retail point of sale system.

A method of making such a card can include extruding a polymeric material, filled or unfilled, such as a polypropylene, polyethylene, filled polypropylene, filled polyethylene, or filled polylactic acid material into a sheet stock, cooling the extruded material to room temperature, optional treating the sheet by corona or flame- treating, or applying an optional coating such as a primer or the like, imaging the sheet by way of surface printing techniques, digital printing, thermal printing, thermal imaging, embossing, and the like, applying a coating over the printed surface of the sheet, optionally polishing the sheet by press-polishing methods, optionally encoding the sheet with a magnetic stripe, RFID, or bar code, and post-processing the finished sheet such as converting to form a card, packaging, shipping, and the like.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

FIG. 1 depicts a front view depicting a card according to an embodiment of the invention.

FIG. 2 depicts a rear view depicting a card according to an embodiment of the invention.

FIG. 3 is a flow chart according to an embodiment of the invention.

FIG. 4 are plastic cards according to embodiments of the invention.

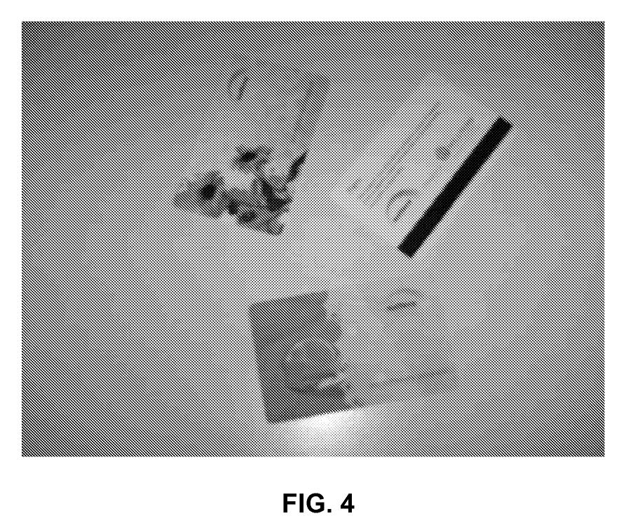

### DETAILED DESCRIPTION OF THE DRAWINGS

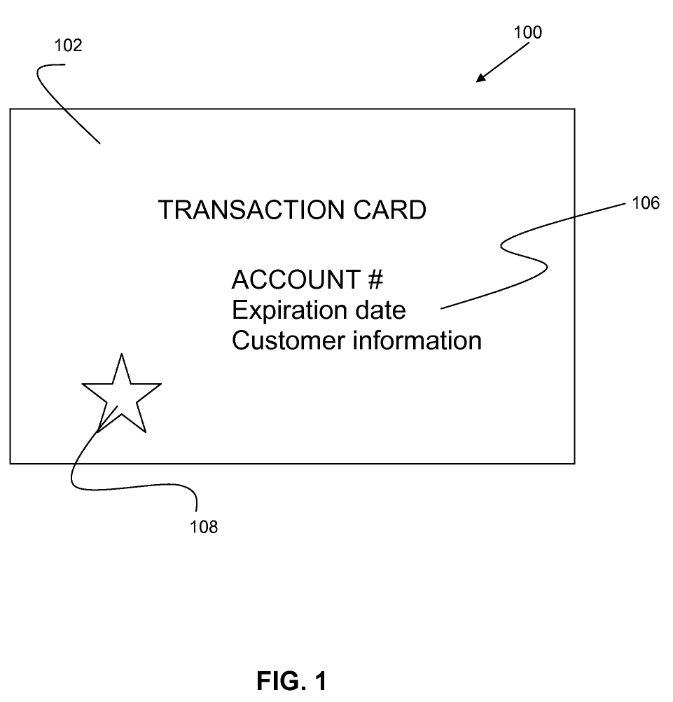

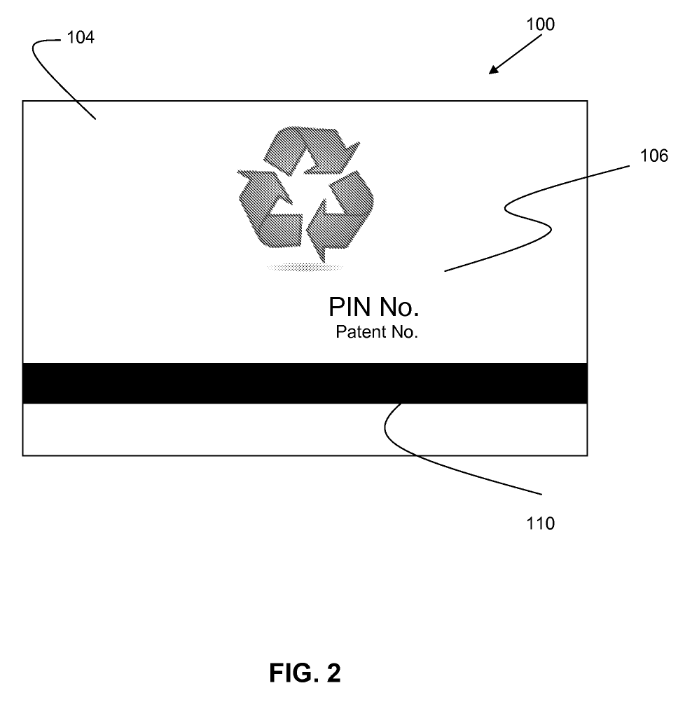

Referring to FIGS. 1 and 2, a plastic card 100 generally can comprise a first major surface 102, a second major surface 104, printed indicia 106, optional graphics 108, and an information carrier 110, such as, for example, a magnetic stripe, barcode, RFID, or the like. In one embodiment of the invention, plastic card 100 can comprise a transaction card or stored value card such as, for example, a credit card, debit card, phone card, gift card, rental card, hotel key passes, and the like. In another embodiment of the invention, plastic card 100 can comprise an identification card, such as, for example, an insurance card, driver's license, security badge, membership card, key card, and other suitable identification cards. In yet another embodiment of the invention, plastic card 100 can comprise an informational or promotional card, such as, for example, a coupon, business card, sports cards, game cards, loyalty cards and other informational or promotional cards. In one embodiment of the invention, plastic card 100 can comprise at least one break-off section comprising a key fob, coupon, panels including a one-piece snap off, or the like.

Lower cost green plastics, such as polypropylene and polyethylene including high density polyethylene (HDPE) and low density polyethylene (LDPE), have well established recycling streams. These materials are less dense than PVC and styrene, and polypropylene can be made more readily from natural gas, rather than oil, than PVC or styrene. These materials are often used to make products such as cups, food containers, bags, films, and the like. Virgin polypropylene and polyethylene are difficult to print, emboss, polish and the like to meet industry standards for plastic cards. However, the inventors have found additional processing steps that promote adhesion characteristics of the polymeric material, which will be described in more detail below.

Plastic card 100 can comprise one or more suitable “green” materials, such as, for example, filled or unfilled polymeric materials including polypropylene, polyethylene, filled polypropylene, filled polyethylene, and/or filled PLA. A filled material is one in which a filler is compounded into the base resin. For example, polypropylene can be made from natural gas rather than oil more readily than PVC and styrene as described above. Therefore, polypropylene made from natural gas would not be subject to the oil price fluctuations. Further, the materials can be provided by local suppliers, rather than depending on foreign suppliers. The materials of the present invention are also less dense than standard PVC and polystyrene, which results in less weight and lower freight cost, ultimately resulting in a lower cost per sheet than other materials. For example, the density of polypropylene is about 0.9-0.95 grams/cm³ whereas the density of PVC is about 1.38-1.41 grams/cm³, and the density of styrene is about 1.05 grams/cm³.

In some embodiments of the invention, plastic card 100 is manufactured using a filled polymeric material such as polypropylene, polyethylene, polylactic acid, and combinations thereof. The polymeric base material can be filled with materials such as, for example, talc, calcium carbonate, titanium dioxide, ash, glass beads, glass fibers, starch, minerals, paper, and other suitable fillers and combinations thereof to form the filled polymeric material. The fillers impart certain opacity, characteristics on the polymeric material such as durability, impact strength, heat stability, and the like. Preferably, the selected filler material exhibits similar environmental characteristics to the polymeric material, such as polypropylene, so that the plastic card 100 can be recycled. One such suitable polymeric material is a filled polypropylene available from Spartech Polycom of Washington, Pennsylvania. The specifications for such a material are attached as Appendix A, which is incorporated herein by reference.

In one embodiment of the invention, the filler is present in an amount from about five percent to about fifty percent by weight. In another embodiment of the invention, the filler is present in an amount from about ten to about thirty percent by weight. In yet another embodiment of the invention, the filler is present in an amount of about twenty percent by weight.

Plastic card 100 can be opaque, semi-opaque, or transparent depending on the combination of polymeric material and filler. In one embodiment of the invention, a filled polymeric material can comprise a pigment in one or both of the polymeric material or the filler such that the resulting card is pigmented.

Plastic card 100 exhibits similar performance characteristics to standard cards made from PVC, styrene, and the like. Plastic card 100 can be encoded, embossed, printed, stamped, polished and the like while exhibiting suitable characteristics to be used in retail point of sale applications. For example, plastic card 100 can be surface printed exhibiting satisfactory printing adhesion. Plastic card 100 can be printed with printed indicia 106 and/or graphics 108 on either first major surface 102, second major surface 104 or both. The printing can be accomplished by digital and conventional printing processes such as, for example, lithography, flexography, inkjet printing such as drop on demand technology, silk screen, gravure, and other suitable printing methodologies.

Printed indica 106 can comprise text, pictures, drawings, symbols, and other indicia that can be printed on a substrate. Such indicia 106 can include, for example, customer name, address, account number, source information such as store or institution information, pin numbers, expiration date, patent or other intellectual property markings, terms and conditions, customer service information, graphics such as the recycle logo, and any of a variety of suitable printed indicia.

Printed indicia 106 can comprise curable inks in a variety of colors and effects, such as a metallic appearance, in one embodiment, although non-curable inks may be used in other embodiments. Suitable inks or surface printing materials can comprise, for example, radiation curable inks such as UV-curable or e-beam curable inks or pastes, thermal inks, solvent-based inks such as an MEK system or a water-based system, solvent-less inks or pastes, colloidal inks or pastes, and any other suitable ink or printing material. In one embodiment of the invention, card 100 is printed with a UV curable ink using ink jet drop on demand technology.

Ink adhesion issues that can result when printing on polypropylene or polyethylene can be overcome by adding primers to the area to be printed, and/or altering the surface condition by surface treatment. Plastic card 100 can also be pretreated before printing. The addition of primers and/or the surface treatment can be accomplished either inline or offline in separate process(es). In one embodiment of the invention, plastic card 100 can be surface treated to promote ink adhesion. Surface treatments can comprise corona treating, plasma treating, and/or flame treating.

In another embodiment of the invention, plastic card 100 can be coated with a coating material, such as a primer, to promote ink adhesion. Such primers may include radiation curable primers such as UV-curable or e-beam curable primers, in either a solvent-based or solvent-less form. One suitable material is a 100% solids, UV-curable acrylate oligimer/monomer blend, commercially available as Thermal Ink Receptive UV RV-4865E, available from both Spring Coating Systems of Jungholtz, France and Performance Coating Corporation in Levittown, Pa. Such coating can be used alone or in combination to the surface treatments described above.

Plastic card 100 can also be further imaged by processes such as, for example, thermal imaging, solvent inkjet, UV inkjet, embossing, laser imaging, hot stamping, foil stamping, and other suitable imaging techniques to form, for example, graphics 108.

An optional coating (not shown) can be applied over at least a portion of first major surface 102 and/or second major surface 104 to at least partially cover any printed indicia 106 and/or graphics 108. One such suitable coating can comprise a UV coating, such as Sovereign 14-88N230, which is subsequently cured by exposure to UV. The UV coating can be a conducive to further process such as, for example, hot stamping, additional printing, and the like.

Other attributes can be added to printed card 100 on first major surface 102 and/or second major surface 104 of card 100 as desired, such as a machine readable feature 110 including magnetic striping, RFID, contact chips, contactless RFID, bar coding, encrypted bar coding, signature panels, and other identifiers and indicia, as depicted in FIG. 2. In one embodiment of the invention, machine readable feature 110 comprises a magnetic stripe applied by a hot stamping process that is subsequently encoded with account information. In an alternative embodiment of the invention, methodologies for providing a bar code can include, for example, thermal imaging, DOD inkjet printing, solvent inkjet printing techniques, and other suitable printing techniques as described above. Such imaging and encoding should meet industry standards such as, for example, ANSI 182-1990, ISO 7811-2, and ISO 7811-6 for imaging and encoding, all of which are incorporated by reference.

To further promote characteristics such as adhesion and imaging properties, plastic card 100 can be polished. Plastic card 100 can press-polished before and/or after printing or imaging. Press-polishing, or planishing, is a finishing process to impart high gloss, improved clarity, and improved mechanical properties. Plastic card 100 is hot pressed against thin, highly polished metal plates. Other suitable polishing techniques can also be used alone, or in combination, with press-polishing. In one embodiment of the invention, first major surface 102 and/or second major surface 104 of plastic card 100 is press-polished. An optional coating can be applied over first major surface 102 and/or second major surface 104 before press polishing to ensure protection of any printed indicia 106 and/or graphics 108.

In one embodiment of the invention, plastic card 100 can be laminated, adhered, fused, and the like to other substrates or materials to create a laminated card. In one embodiment, plastic card 100 is combined with a lenticular lens to produce a lenticular card. The lenticular lens can also be manufactured using a green polymer, such as polypropylene, polyethylene, polylactic acid, and the like. In another embodiment, plastic card 100 can be comprise a laminate over one or both surfaces of plastic card 100. The laminate can comprise, for example, a clear material formed from the same polymeric material as the base material of plastic card 100, or can be formed form a different polymeric material, such as another green material.

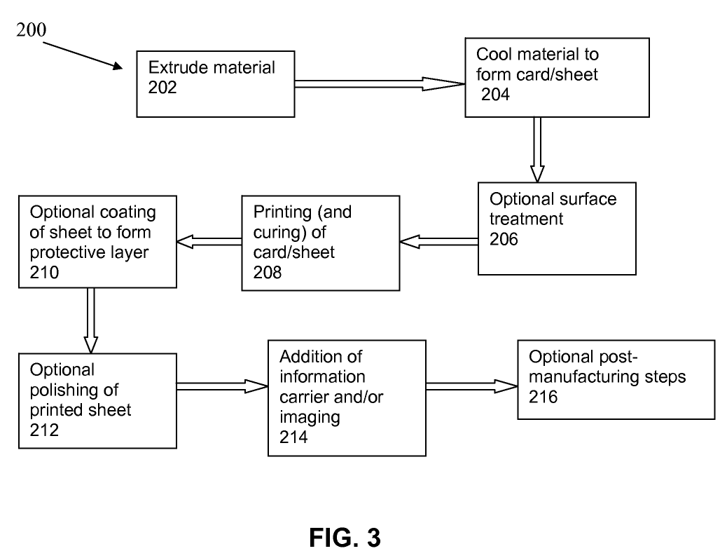

Referring now to FIG. 3, a method 200 for manufacturing plastic cards is shown according to embodiments of the present invention. In one embodiment of the invention, a filled polypropylene material is extruded at step 202 using standard extrusion techniques. The extruded material is formed and cooled into sheet stock at step 204. The extruded sheet stock is then optionally surface treated at step 206 using corona treatment, plasma treatment, flame treatment and the like. In an alternative embodiment, an optional coating, such as an adhesion promoter or primer as described above, is applied to at least a portion the sheet stock. The optional coating can be accomplished by standard methods such as, for example, roll coating, curtain coating, spray coating, litho printing, and the like. If needed, the primer can be cured using one or more curing stations such as UV, IR, thermal, and the like stations.

One or more surfaces of the sheet stock is then printed at step 208 using any of a variety of printing techniques described supra. One or more printing stations can be used alone or in combination to print at least a portion of the sheet stock. Optional curing stations, such as UV, IR, thermal, and the like stations, can be used to cure the printing inks or materials.

An optional coating or protective layer can be applied at step 210 over the first surface, the second surface, or both to protect any printed indicia. Such coating can include, for example, a radiation-curable coating, such as a UV-coating that is printable, hot-stampable, embossable, or the like. In one embodiment of the invention, the optional coating is a UV-curable material that is subsequently exposed to UV light to cure the coating, thereby forming the protective layer.

One or more surfaces of the printed sheet stock can then be optionally polished at step 212, such as press-polished, to improve the gloss for improved downstream processability.

One or more machine readable features, such as a magnetic stripe, barcode, or RFID, are optionally applied in step 214 to one or more surfaces of the sheet stock by means of hot stamping, printing, laminating, and other suitable means of applying. In one embodiment of the invention, machine readable feature comprises a magnetic strip that can be extruded onto the sheet stock. In other embodiments of the invention, an optional magnetic stripe can be applied to the sheet stock at any time in the process such as, for example, prior to printing, after printing, and/or on individual cards after converting the sheet stock. In one particular embodiment of the invention, one or more magnetic stripes can be applied pursuant to U.S. Pat. No. 7,300,535 entitled “Magnetically Readable Card and a Method of Making a Magnetically Readable Card,” which is incorporated herein in its entirety.

The sheet stock is then optionally imaged using thermal, laser, embossing, and the like in step 214. The imaging and encoding can be conducted in the same processes step. If a hot stamp unit is placed in front of the encode unit, the magnetic stripe can be applied to individual cards directly before encoding.

Post processing step 216 can include, for example, converting, collating, packaging, additional coatings, such as protective coatings, laminating, and any of a variety of post-processing steps. In one embodiment of the invention, the filled polypropylene material is extruded as sheet stock in step 202. The sheet stock is converted to suitable sizes according to industry standards, so as to form a card such as, for example, a CR80, M6E, or M6 card. A CR80 card is a standard card size having dimensions of about 3.375″×2.125″ (85.6 mm×54 mm). An M6E is a standard card size having dimensions of 3⅜″×5 5/16″ without a snap-off feature, and an M6 card is a standard card size having dimensions of 3⅜″×5½″ with a snap-off feature created by a die-lines.

The method of manufacture is not limited to the sequence of steps as depicted in FIG. 3. Other flow paths can include after the extrusion step, for example: (1) printing of sheets, cutting out cards, applying information carrier(s), followed by imaging and encoding of the cards; (2) applying information carrier(s) to full sheets, printing of sheets, cutting cards, followed by imaging and encoding cards; (3) printing of sheets, applying information carrier(s) to the sheets, cutting out cards, followed by imaging and encoding cards; (4) printing of sheets, cutting out cards, applying information carriers to the cards, followed by imaging and encoding the cards in the same process step; and (5) printing of sheets, press-polishing and apply information carriers simultaneously, cutting the cards, followed by imaging and encoding the cards. In alternative embodiments, some or all cards may omit the encoding step. All contemplated flow paths can be used in manufacturing of the plastic cards.

Embodiments of the present invention can be further illustrated in the following examples:

### EXAMPLE 1

A filled polypropylene was extruded to form a sheet stock having a thickness of about 30 mils, and having a matte surface on a first side, and a gloss surface on a second side. The matte side was printed using a 4-color process with UV-curable inks that were subsequently cured. A UV-curable coating, such as a hot stampable coating, was applied over the ink layer and subsequently cured.

The glossy back side was printed with a black UV-curable ink that was subsequently cured. A UV-curable coating, such as a clear matte tint base varnish, was applied over the printed layer and was subsequently cured. A magnetic stripe was applied to the glossy side by hot stamping.

The filled polypropylene material embossed well, but the foil adhesion of the magnetic stripe was poor. At least one of primer and surface conditioning, such as an alcohol bath or corona treatment, before printing improved ink adhesion to meet ISO specifications. The card passed ISO environmental requirements for heat and humidity, e.g. no curl was observed.

### EXAMPLE 2

A filled polypropylene was extruded to form a sheet stock having a thickness of about 30 mils, and having a matte surface on a first side, and a gloss surface on a second side. The matte side was printed using a 4-color process with UV-curable inks that were subsequently cured. A UV-curable coating, such as a hot stampable coating was applied over the ink layer and subsequently cured.

The glossy back side was printed with a black UV-curable ink that was subsequently cured. A UV-curable coating, such as a clear matte tint base varnish, was applied over the printed layer and was subsequently cured. A magnetic strip was applied to the back side by hot stamping. The back side sheet was then press polished.

The filled polypropylene material embossed satisfactorily. However, the press polishing needed to be run at low temperature and high pressure to avoid melting of the polypropylene as difference between the softening temperature and the melting temperature is narrow to get the material to polish out. A combination of primer and surface conditioning, such as an alcohol bath or corona treatment, before printing improved ink adhesion to meet ISO specifications. The resulting card passed ISO environmental requirements for heat and humidity, e.g. no curl was observed.

### EXAMPLE 3

A filled polypropylene sheet stock having a thickness of about 28.5 mils was used, and having a matte surface on a first side, and a gloss surface on a second side. The matte side was printed using a 4-color process with UV-curable inks that are subsequently cured. A UV-curable coating, such as a hot stampable coating was applied over the ink layer and subsequently cured.

The glossy back side was printed with a black UV-curable ink that was subsequently cured. A UV-curable coating, such as a clear matte tint base varnish, was applied over the printed layer and was subsequently cured.

A polypropylene laminate with adhesive, such as an oriented polypropylene (OPP) 2 mil film, was laminated to both sides of the sheet stock using a belt laminator. An optional magnetic stripe was fed into the belt laminator for laminating to the sheet stock with OPP film.

The magnetic stripe did not adhere to the OPP film. However, a combination of primer and surface conditioning, such as an alcohol bath or corona treatment, before printing improved ink adhesion to meet ISO specifications. The card passed ISO environmental requirements for heat and humidity, e.g. no curl was observed.

A recyclable plastic card according to the embodiments of the invention can reduce the negative impacts on the environment that standard PVC or styrene cards create. Both waste from the manufacture of such cards and discarded cards can be recycled. The plastic card of the present invention is readily recyclable in that materials are used that have established recycling streams. Further, the materials used to manufacture the plastic cards of the present invention cost less, are less dense, and can be locally supplied. The plastic cards of the present invention meet many of the industry standards, and perform similar to the standard PVC or styrene cards in retail point of sale applications.

The plastic cards of the present invention provide further advantages to traditional PVC and styrene transaction cards. For example, polypropylene and polyethylene exhibit more durable behavior than PVC and styrene, and tend to be more resistant to tearing, having a higher tear strength than either PVC or styrene.

The invention therefore addresses and resolves many of the deficiencies and drawbacks previously identified. The invention may be embodied in other specific forms without departing from the essential attributes thereof, therefore, the illustrated embodiments should be considered in all respects as illustrative and not restrictive.

What is claimed:

1. A transaction card comprising:
a sheet of polymeric material including a polymeric base material and a filler in the amount from about five to about fifty weight percent, the sheet presenting a first major surface and a second major surface; and
an image layer deposited on at least a portion of the first surface, the second surface, or both,
wherein the polymeric base material is selected from the group consisting of polypropylene, polyethylene, polylactic acid, and combinations thereof, and
wherein the transaction card meets ISO requirements for dimensional stability regarding heat and humidity exposure.

2. The transaction card according to claim 1, wherein the filler is selected from the group consisting of talc, calcium carbonate, titanium dioxide, ash, glass beads, glass fibers, starch, minerals, paper, and combinations thereof.

3. The transaction card according to claim 1, wherein the filler is present in an amount from about ten to about thirty weight percent.

4. The transaction card according to claim 3, wherein the filler is present in an amount of about twenty weight percent.

5. The transaction card according to claim 1, further comprising:
at least one machine readable feature deposited on at least one of the first major surface and the second major surface, wherein the at least one machine readable feature is selected from a group consisting of a magnetic stripe, barcode, contact chip, contactless RFID, and combinations thereof.

6. The transaction card according to claim 1, wherein the polymeric material is opaque or semi-opaque.

7. The transaction card according to claim 1, further comprising:
a protective layer formed over at least a portion of the image layer on at least one of the first major surface and the second major surface.

8. The transaction card according to claim 7, wherein the at least one of the first major surface and second major surface having the protective layer is press-polished.

9. The transaction card according to claim 1, further comprising:
a clear laminate covering at least one of the first major surface and the second major surface, wherein the clear laminate is formed form the polymeric base material.

10. A transaction card comprising:
a sheet of polymeric material selected from the group consisting of polypropylene, polyethylene, and combinations thereof, the sheet presenting a first major surface and a second major surface; and
an image layer deposited on at least a portion of the first surface, the second surface, or both,
wherein the transaction card meets ISO requirements for dimensional stability regarding heat and humidity exposure.

11. The transaction card according to claim 10, wherein the polymeric material further comprises a filler selected from the group consisting of talc, calcium carbonate, titanium dioxide, ash, glass beads, glass fibers, starch, minerals, paper, and combinations thereof.

12. The transaction card according to claim 11, wherein the filler is present in an amount from about ten to about thirty weight percent.

13. The transaction card according to claim 12, wherein the filler is present in an amount of about twenty weight percent.

14. The transaction card according to claim 10, further comprising:
at least one machine readable feature deposited on at least one of the first major surface and the second major surface, wherein the at least one machine readable feature is selected from a group consisting of a magnetic stripe, barcode, contact chip, contactless RFID, and combinations thereof.

15. The transaction card according to claim 10, wherein the polymeric material is opaque, semi-opaque, or transparent.

16. The transaction card according to claim 10, further comprising:
a protective layer formed over at least a portion of the image layer on at least one of the first major surface and the second major surface.

17. The transaction card according to claim 16, wherein the at least one of the first major surface and second major surface having the protective layer is press-polished.

18. The transaction card according to claim 11, further comprising:
a clear laminate covering at least one of the first major surface and the second major surface, wherein the clear laminate is formed form the polymeric material.

19. A sheet for forming a plurality of transaction cards therefrom, the sheet comprising:
a polymeric material including a polymeric base material and a filler in the amount from about five to about fifty weight percent, the sheet presenting a first major surface and a second major surface, wherein the polymeric base material is selected from the group consisting of polypropylene, polyethylene, polylactic acid, and combinations thereof, and
a printed layer on at least a portion of the first major surface, the second major surface, or both;
wherein the transaction card meets ISO requirements for dimensional stability regarding heat and humidity exposure.

20. The sheet according to claim 19, wherein the filler is selected from the group consisting of talc, calcium carbonate, titanium dioxide, ash, glass beads, glass fibers, starch, minerals, paper, and combinations thereof.

21. The sheet according to claim 19, wherein the filler is present in an amount from about ten to about thirty weight percent.

22. The sheet according to claim 21, wherein the filler is present in an amount of about twenty weight percent.

23. The sheet according to claim 19, further comprising:
at least one machine readable feature deposited on at least one of the first major surface and the second major surface, wherein the at least one machine readable feature is selected from a group consisting of a magnetic stripe, barcode, contact chip, contactless RFID, and combinations thereof.

24. The sheet according to claim 19, wherein the polymeric material is opaque or semi-opaque.

25. The sheet according to claim 19, further comprising:
a protective layer formed over at least a portion of the image layer on at least one of the first major surface and the second major surface.

26. The sheet according to claim 25, wherein the at least one of the first major surface and second major surface having the protective layer is press-polished.

27. The sheet according to claim 19, further comprising:
a clear laminate covering at least one of the first major surface and the second major surface, wherein the clear laminate is formed form the polymeric base material.
